(19) United States
(12) Patent Application Publication
(10) Pub. No.: US 2025/0123304 A1
(43) Pub. Date: Apr. 17, 2025

(54) SENSOR APPARATUS AND SENSING METHOD

(71) Applicant: SEIKO EPSON CORPORATION, Tokyo (JP)

(72) Inventor: Ryuji Kihara, Matsumoto-shi (JP)

(21) Appl. No.: 18/911,207

(22) Filed: Oct. 9, 2024

(30) Foreign Application Priority Data
Oct. 11, 2023 (JP) 2023-175687

(51) Int. Cl. G01P 15/18

(52) U.S. Cl. CPC G01P 15/18

(57) ABSTRACT

A sensor apparatus includes: two or more detection elements; a storage section configured to store respective drive frequencies of the two or more detection elements; and a processing section configured to, in accordance with respective detection signals output from the two or more detection elements, obtain a statistical signal by making statistics of the detection signals, attenuate an interference signal in a frequency band in accordance with the respective drive frequencies from the statistical signal, thereby outputting detection data.

The present application is based on, and claims priority from JP Application Serial Number 2023-175687, filed Oct. 11, 2023, the disclosure of which is hereby incorporated by reference herein in its entirety.

### BACKGROUND

### 1. Technical Field

The present disclosure relates to a sensor apparatus and a sensing method.

### 2. Related Art

A sensor apparatus including a plurality of sensor devices has been known. For example, JP-A-2021-196191 discloses a sensor apparatus including a plurality of sensor devices. In JP-A-2021-196191, individual sensor devices are able to output signals on a plurality of detection axes, and the individual detection axes are perpendicular to each other. In a sensor apparatus including a plurality of sensor devices, when the detection axes are misaligned, the detection accuracies of physical quantities might deteriorate. Accordingly, in JP-A-2021-196191, correction for aligning the detection axes of the individual sensor devices is performed.

In the related-art technique, the detection accuracy sometimes decreases by an interference signal caused by using a plurality of sensor devices.

Specifically, when the respective drive frequencies for driving detection elements are close in a plurality of sensor devices, the respective detection signals output from the sensor devices sometimes interfere with each other to create noise, and thus the detection accuracy sometimes decreases.

### SUMMARY

According to an aspect of the present disclosure, there is provided a sensor apparatus including: two or more detection elements; a storage section configured to store respective drive frequencies of the two or more detection elements; and a processing section configured to, in accordance with respective detection signals output from the two or more detection elements, obtain a statistical signal by making statistics of the detection signals, attenuate an interference signal in a frequency band in accordance with the respective drive frequencies from the statistical signal, and output the statistical signal as detection data.

According to another aspect of the present disclosure, there is provided a sensor apparatus including: two or more detection elements; and a processing section configured to, in accordance with respective detection signals output from the two or more detection elements, obtain a statistical signal by making statistics of the detection signals, attenuate an interference signal having a frequency lower than or equal to a predetermined frequency from the statistical signal, and output the statistical signal as detection data.

According to still another aspect of the present disclosure, there is provided a sensing method including: in accordance with respective detection signals output from two or more detection elements, obtaining a statistical signal by making statistics of the detection signals; and attenuating an interference signal in a frequency band in accordance with drive frequencies of the two or more detection elements stored in advance from the statistical signal and outputting the statistical signal as detection data.

### BRIEF DESCRIPTION OF THE DRAWINGS

FIG. 1 is a block diagram illustrating an example of the configuration of a sensor apparatus.

FIG. 2 is a block diagram illustrating an example of the configuration of a sensor device.

FIG. 3 is a flowchart explaining the processing performed by a processing section.

FIG. 4 is a diagram illustrating an example of drive frequencies.

FIG. 5 is a diagram illustrating an example of the differences between the drive frequencies.

FIG. 6 is a diagram illustrating an example of the configuration of a second-order IIR filter.

FIG. 7 is a diagram illustrating an example of the drive frequencies.

### DESCRIPTION OF EMBODIMENTS

In the following, a detailed description will be given of preferred embodiments of the present disclosure. In this regard, the embodiments described below do not restrict the contents of the present disclosure described in the scope of the claims. Note that not all the components described in the present embodiments are necessarily mandatory as the solution of the present disclosure.

### 1. First Embodiment

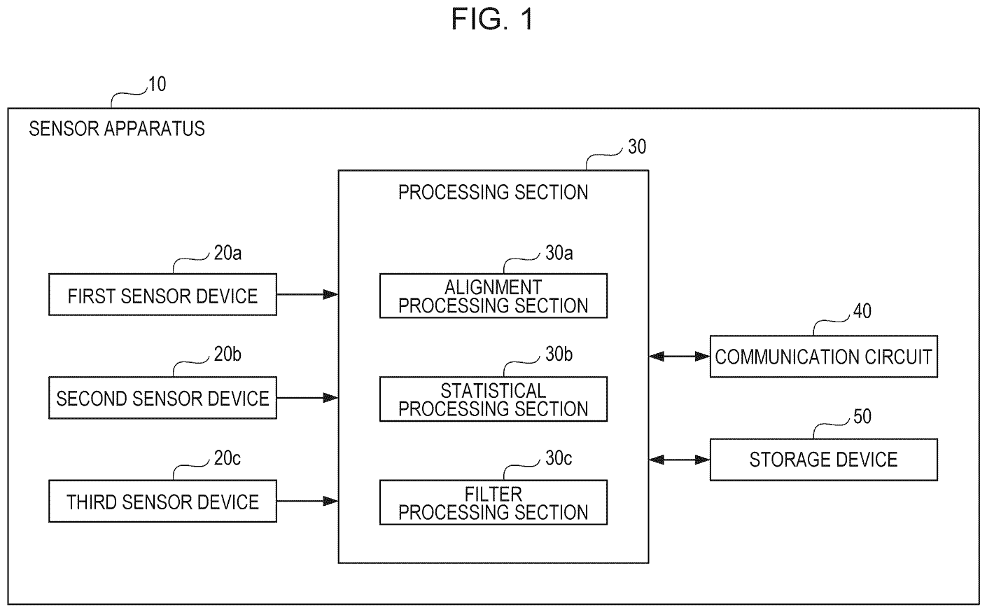

FIG. 1 is a block diagram illustrating the configuration of a sensor apparatus 10 according to the present embodiment. As illustrated in FIG. 1, the sensor apparatus 10 includes a first sensor device 20a, a second sensor device 20b, a third sensor device 20c, a processing section 30, a communication circuit 40, and a storage device 50.

The communication circuit 40 is a circuit for communicating between the sensor apparatus 10 and an external device, and is electrically coupled to respective connection terminals of the sensor apparatus 10 and the external device. The communication circuit 40 is able to perform various kinds of communication, and, for example, outputs detection data obtained by the processing described later performed by the processing section 30 to the external device.

The processing section 30 functions as an alignment processing section 30a, a statistical processing section 30b, and a filter processing section 30c. The processing section 30 may be realized by various circuits. It is possible to employ various logic operation circuits, such as an MCU (micro controller unit), an application specific integrated circuit (ASIC), or the like as a circuit that constitutes at least a part of the processing section 30. In the present embodiment, it is assumed that the configuration in which digital processing is performed by the MCU of the processing section 30 on the digital signal output from a sensor device is used. However, the processing section 30 may include a processing circuit such as an A/D converter or the like, and the processing may be performed such that the processing section 30 performs digital conversion on the analog signal output from the sensor device.

The storage device 50 is a nonvolatile storage device, for example, a semiconductor memory or the like. The storage device 50 stores a correction coefficient for performing alignment processing described later. The correction coefficient includes a correction coefficient, such as a rotation matrix or the like to be used when correction is performed all of at least two or three of the first sensor device 20a, the second sensor device 20b, and the third sensor device 20c. Each correction coefficient is stored in association with a sensor device to be corrected.

Further, in the present embodiment, the storage device 50 stores filter setting data to be applied to an IIR (infinite impulse response) filter 31 described later. The IIR filter 31 described later functions as a band stop filter that attenuates various frequency bands. A plurality of the frequency bands are set, a filter coefficient for realizing a band stop filter for each frequency band is identified in advance, and is stored in the storage device 50 as filter setting data in association with a frequency band. In this regard, the processing section 30 and the storage device 50 may be configured by all-in-one hardware or by multiple separate hardware.

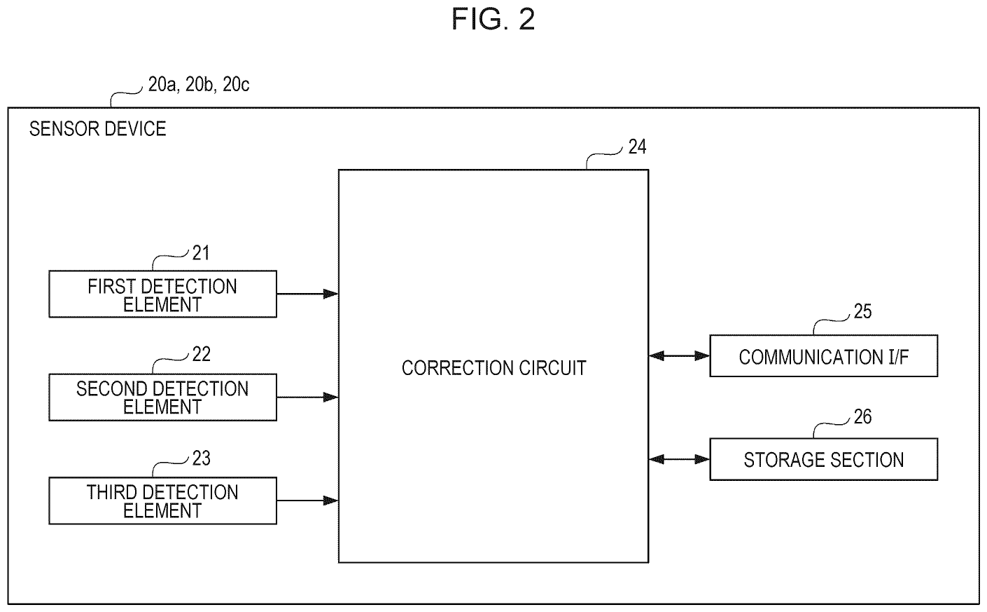

The first sensor device 20a, the second sensor device 20b, and the third sensor device 20c are individual sensor devices having the same configuration. FIG. 2 is a diagram illustrating the configuration of these sensor devices. The first sensor device 20a, the second sensor device 20b, and the third sensor device 20c have the common configuration, and thus when not explicitly distinguishing these, the first sensor device 20a, the second sensor device 20b, and the third sensor device 20c are sometimes referred to simply as a sensor device.

As illustrated in FIG. 2, the sensor device (20a, 20b, and 20c) includes a first detection element 21, a second detection element 22, a third detection element 23, a correction circuit 24, a communication interface (I/F) 25, and a storage section 26. The communication I/F 25 is electrically coupled to the processing section 30.

The first detection element 21, the second detection element 22, and the third detection element 23 are the elements that detect physical quantities on a first axis, a second axis, and a third axis, which are perpendicular to each other, respectively. The physical quantities are not limited. However, the elements that detect angular accelerations are assumed here. The first axis, the second axis, and the third axis only need to be perpendicular to each other, and are sometimes referred to as an X-axis, a Y-axis, and a Z-axis respectively.

The first detection element 21, the second detection element 22, and the third detection element 23 detect respective angular accelerations around axes vertical to the faces on which the respective elements are mounted. The first detection element 21, the second detection element 22, the third detection element 23 are mounted on respective substrates not illustrated in the figure so as to be perpendicular to each other, and configured so that the respective axes of the angular accelerations are perpendicular to each other.

In the present embodiment, the first sensor device 20a, the second sensor device 20b, and the third sensor device 20c individually include the first detection element 21, the second detection element 22, and the third detection element 23. The first sensor device 20a, the second sensor device 20b, and the third sensor device 20c are able to detect the angular accelerations about the three axes, that is, the X-axis, the Y-axis, and the Z-axis respectively.

Accordingly, the first sensor device 20a, the second sensor device 20b, and the third sensor device 20c individually include the first detection element 21 that outputs a detection signal for detecting the physical quantity about the identical X-axis. Also, the first sensor device 20a, the second sensor device 20b, and the third sensor device 20c individually include the second detection element 22 that outputs a detection signal for detecting the physical quantity about the identical Y-axis. Further, the first sensor device 20a, the second sensor device 20b, and the third sensor device 20c individually include the third detection element 23 that outputs a detection signal for detecting the physical quantity about the identical Z-axis.

Further, the first sensor device 20a includes the first detection element 21, the second detection element 22, and the third detection element 23 that output detection signals for detecting physical quantities about the respective different axes. Also, the second sensor device 20b includes the first detection element 21, the second detection element 22, and the third detection element 23 that output detection signals for detecting physical quantities about the respective different axes. The third sensor device 20c includes the first detection element 21, the second detection element 22, and the third detection element 23 that output detection signals for detecting physical quantities about the respective different axes.

The axes about which angular accelerations are to be detected are designed to be common to all of the first sensor device 20a, the second sensor device 20b, and the third sensor device 20c. However, due to misalignment of each element when being mounted on a substrate, in a detection element of a certain sensor device, the X-axis, the Y-axis, and the Z-axis might slightly deviate from perpendicularity with each other. For example, in a certain sensor device, the X-axis, which is a detection axis of the first detection element 21, and the Y-axis, which is the detection axis of the second detection element 22, might slightly deviate from perpendicularity.

Also, the detection elements in different sensor devices might have identical axes that slightly deviate from parallelism with each other. For example, the X-axis which is the detection axis of the first detection element 21 in the first sensor device 20a, and the X-axis which is the first detection axis of the first detection element 21 in the second sensor device 20b might slightly deviate from parallelism. Accordingly, the present embodiment includes the configuration for correcting the errors caused by these misalignments.

In the present specification, the correction of the errors caused by misalignment of detection elements in a single sensor device is referred to as in-sensor correction processing. On the other hand, the correction of the errors caused by misalignment of detection elements between different sensor devices is referred to as alignment processing.

The storage section 26 is a storage device that stores various kinds of information. In the present embodiment, the information stored in the storage section 26 includes various parameters and drive frequencies of the detection elements that are used when the correction circuit 24 performs in-sensor correction processing. The parameters include a correction coefficient, such as a rotation matrix described later or the like to be used when all of at least two or three of the first detection element 21, the second detection element 22, and the third detection element 23 are corrected. The correction coefficients are stored in association with the respective detection elements to be corrected.

The drive frequencies are respective frequencies when the first detection element 21, the second detection element 22, and the third detection element 23 that are included in the sensor device are driven. The drive frequencies depend on the natural frequencies of the respective elements included in the first detection element 21, the second detection element 22, and the third detection element 23. Accordingly, even when the elements are produced by the same design, the drive frequencies might be slightly different from each other. In the present embodiment, the respective drive frequencies of the first detection element 21, the second detection element 22, and the third detection element 23 are measured in advance and are stored in the storage section 26.

The first detection element 21, the second detection element 22, and the third detection element 23 output analog detection signals indicating the physical quantities on the respective detection axes to the correction circuit 24. The correction circuit 24 converts the analog detection signal to digital detection signals by using A/D converters not illustrated in FIG. 2. The correction circuit 24 then corrects the digitally converted detection signals output from the first detection element 21, the second detection element 22, and the third detection element 23 so that a plurality of detection axes become perpendicular to each other. Specifically, the correction circuit 24 refers to the storage section 26 and obtains the correction coefficients, such as rotation matrixes or the like, stored as the parameters for correction. The correction circuit 24 then applies the correction coefficients associated with the respective detection elements to the respective detection signals output from the first detection element 21, the second detection element 22, and the third detection element 23 so as to perform the in-sensor correction processing. The correction may include the correction on offset errors and scale factor errors included in the detection signals. When the detection signals are corrected, the corrected detection signals are output to the processing section 30 via the communication I/F 25.

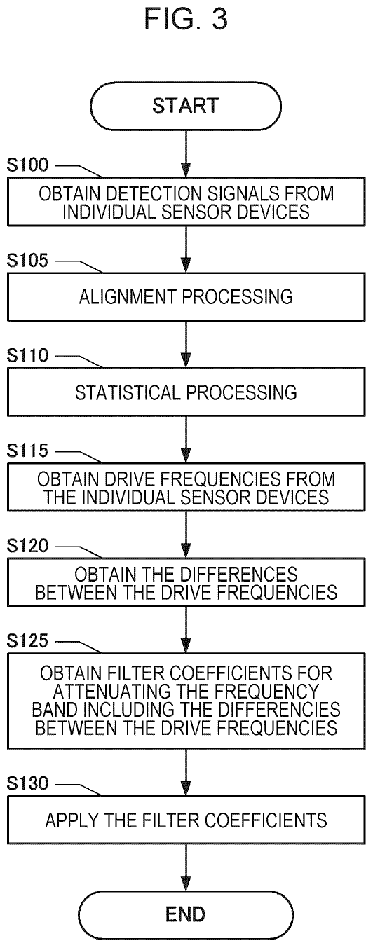

Returning back to FIG. 1 and the explanation will be continued. The processing in the processing section 30 is started when a fixed condition (for example, elapse of a predetermined period or the like) is met after the power to the sensor apparatus 10 is turned on. The processing in the processing section 30 is performed in accordance with a flowchart illustrated in FIG. 3. When the processing is started, the processing section 30 obtains detection signals from the individual sensor devices (step S100). That is, the first sensor device 20a, the second sensor device 20b, and the third sensor device 20c output digital detection signals indicating the respective physical quantities detected on the X-axis, the Y-axis, and the Z-axis. The processing section 30 obtains the detection signals about the individual axes transmitted from the individual sensor devices via an interface not illustrated in FIG. 1.

Next, the processing section 30 performs alignment processing by using the alignment processing section 30a (step S105). Specifically, the alignment processing section 101 performs alignment processing, which is the correction of errors caused by misalignment of detection elements between different sensor devices. The correction is performed by multiplying the detection signals output from the sensor devices to be corrected by the respective correction coefficients stored in the storage device 50.

For example, when performing the correction for aligning a detection axis in the first sensor device 20a with a detection axis in the second sensor device 20b, the alignment processing section 30a applies the correction coefficients associated with the first sensor device 20a to the detection signal output from the first sensor device 20a. In this case, the correction coefficients are the coefficients for eliminating misalignment of the first sensor device 20a with respect to the second sensor device 20b. Also, the correction coefficients are the coefficients that rotate the detection axes of the first sensor device 20a so as to align the detection axes of the first sensor device 20a with the detection axes of the second sensor device 20b as a reference. The correction coefficients may be any one type of rotation matrixes, Euler angles, and quaternions.

In this case, further, the alignment processing section 30a applies the correction coefficients associated with the third sensor device 20c to the detection signals output from the third sensor device 20c to perform the alignment processing. In this case, the correction coefficients are the coefficients for eliminating misalignment of the third sensor device 20c with respect to the second sensor device 20b. Also, the correction coefficients are the coefficients that rotate the detection axes of the third sensor device 20c so as to align the detection axes of the third sensor device 20c with the detection axes of the second sensor device 20b as a reference. Here, the correction coefficients may be any one type of rotation matrixes, Euler angles, and quaternions.

Of course, the alignment processing described above is an example, and the reference to be used when the alignment processing is performed may be a sensor device other than the second sensor device 20b, and the alignment processing may be correction for aligning all of the first sensor device 20a, the second sensor device 20b, and the third sensor device 20c with respect to any reference.

Next, the processing section 30 performs statistical processing by the statistical processing section 30b (step S110). Specifically, the statistical processing section 30b obtains statistical signals by making statistics of the detection signals in accordance with the detection signals after the alignment processing has been performed by the alignment processing section 30a. That is, the statistical processing section 30b makes statistics of the signals after the alignment processing has been performed on the detection signals output from the first sensor device 20a, the second sensor device 20b, and the third sensor device 20c. The statistics may be made by various kinds of methods and are made by averaging processing in the present embodiment.

The averaging processing is the processing for improving the statistical accuracies of the physical quantities on the individual axes. Accordingly, the averaging processing is performed for each of the axes. Specifically, the statistical processing section 30b gets the average of the detection signals on identical axes output from the different sensor devices. For example, the statistical processing section 30b obtains a signal corresponding to the average of the detection signal output from the first detection element 21 of the first sensor device 20a, the detection signal output from the first detection element 21 of the second sensor device 20b, and the detection signal output from the first detection element 21 of the third sensor device 20c as a statistical signal. The statistics are made on the individual axes. From the above results, statistical signals are obtained about the X-axis, the Y-axis, and the Z-axis. In general, when statistics are obtained in accordance with N samples, noise becomes about 1/N^{1/2}. Accordingly, when two or more sensor devices are used, it is possible to improve the statistical accuracy compared with the case of using fewer sensor devices.

Next, the processing section 30 performs filter processing by the filter processing section 30c (step S115 to S130). Specifically, the filter processing section 30c attenuates interference signals in a frequency band in accordance with respective drive frequencies from the statistical signal, and outputs the statistical signals as detection data. That is, the filter processing section 30c eliminates the interference signals caused by different drive frequencies by the filter processing.

The statistical signals obtained by the statistical processing section 30b as described above may include interference signals. The interference signals occur by driving the detection elements by using different drive frequencies and might occur at individual frequencies corresponding to the difference and the sum of two drive frequencies selected from any drive frequencies with each other. However, in the present embodiment, the frequency corresponding to the sum of the drive frequencies is in a frequency band different from the frequency band of the statistical signals handled by the processing section 30, thus is able to be eliminated by using a filter not illustrated in the figure, and is not a filtering target of the filter processing section 30c. That is, in the present embodiment, the filter processing section 30c attenuates the signals in the frequency bands including the difference between the respective drive frequencies with each other.

Also, even for the frequencies corresponding to the difference between any drive frequencies with each other, the signal components having a low power spectral density, and the frequencies that are able to be eliminated by a filter (for example, a filter that extracts only the statistical signals to be used for detection) or the like, not illustrated in the figure, disposed separately from the filter processing section 30c may not be the target of the processing performed by the filter processing section 30c. In the present embodiment, the interference signals in the frequency band relatively close to the frequency band of the signals used as statistical signals become the target of the processing performed by the filter processing section 30c.

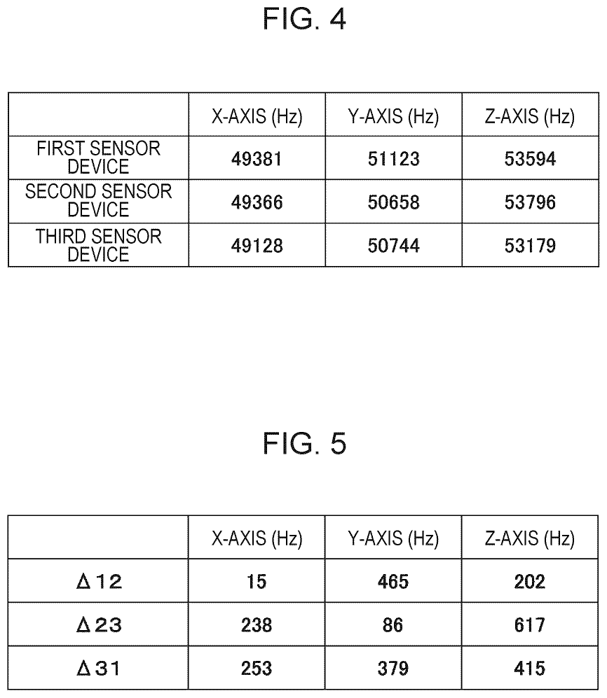

FIG. 4 illustrates the drive frequencies of the first detection element 21 (X-axis), the second detection element 22 (Y-axis), and the third detection element 23 (Z-axis) individually included in the first sensor device 20a, the second sensor device 20b, and the third sensor device 20c according to the present embodiment. In the present embodiment, even with different sensor devices, when the target axis is the same, the difference between the drive frequencies becomes relatively small, whereas with the same sensor device, when the target axis is different, the difference between the drive frequencies becomes relatively large. For example, the drive frequency of the first detection element 21 included in the second sensor device 20b and the third sensor device 20c are 49366 Hz and 49128 Hz respectively as illustrated in FIG. 4, and thus the difference between the two is 238 Hz.

On the other hand, the drive frequencies of the first detection element 21 and the second detection element 22 in the second sensor device 20b are 49366 Hz and 50658 Hz respectively as illustrated in FIG. 4, and the difference between the two is 1292 Hz. In the present embodiment, the difference between the drive frequencies of the detection elements on the same axis with each other is smaller than 1000 Hz, and the difference between the drive frequencies of the detection elements on the different axes is larger than 1000 Hz.

FIG. 5 is a diagram illustrating the absolute value of the difference between the drive frequencies of the detection elements on the same axis with each other. A sign 412 indicates the differences between the drive frequencies of the detection elements in the first sensor device 20a and the drive frequencies of the detection elements in the second sensor device 20b. A sign 423 indicates the differences between the drive frequencies of the detection elements in the second sensor device 20b and the drive frequencies of the detection elements in the third sensor device 20c. A sign 431 indicates the differences between the drive frequencies of the detection elements in the third sensor device 20c and the drive frequencies of the detection elements in the first sensor device 20a.

In the present embodiment, the interference signals exceeding 1000 Hz are able to be eliminated by a filter disposed separately from the filter processing section 30c or the like, and thus interference signals are not the target of the processing performed by the filter processing section 30c. On the other hand, the interference signals lower than 1000 Hz are the target of the processing performed by the filter processing section 30c.

That is, in the present embodiment, the drive frequencies of the detection elements are selected such that the filter processing section 30c only needs to perform processing on the interference signals that occur between the detection elements for the same axis, and the interference signals that occur between the detection elements for the different axes does not need to be processed by the filter processing section 30c. Thus, in the present embodiment, the filter processing section 30c attenuates the interference signals in the frequency band in accordance with the respective drive frequencies of the detection elements that detect the physical quantities about the identical axes from the statistical signal, and outputs the statistical signal as detection data.

Specifically, the filter processing section 30c obtains drive frequencies from the individual sensor devices (step S115). That is, the filter processing section 30c obtains the respective drive frequencies of the first detection element 21 to the third detection element 23 from the storage section 26 in the first sensor device 20a, and obtains the respective drive frequencies of the first detection element 21 to the third detection element 23 from the storage section 26 in the second sensor device 20b. Further, the filter processing section 30c obtains the respective drive frequencies of the first detection element 21 to the third detection element 23 from the storage section 26 in the third sensor device 20c.

Next, the filter processing section 30c obtains the differences between the respective drive frequencies (step S120). In the present embodiment, for eliminating the interference signals that occur on the detection elements that detect the physical quantities on the identical axes, the filter processing section 30c obtains the differences for individual axes. Specifically, the filter processing section 30c obtains the absolute values of the differences of all of the combinations obtained by extracting two from the drive frequency of the first detection element 21 in the first sensor device 20a, the drive frequency of the first detection element 21 in the second sensor device 20b, and the drive frequency of the first detection element 21 in the third sensor device 20c. For example, in the case of the X-axis illustrated in FIG. 4, the filter processing section 30c obtains 412, 423, and 431 on the X-axis illustrated in FIG. 5. The filter processing section 30c obtains the differences for all the combinations on the Y-axis and the Z-axis in the same manner. In the case of the example illustrated in FIG. 4, all the differences illustrated in FIG. 5 are obtained.

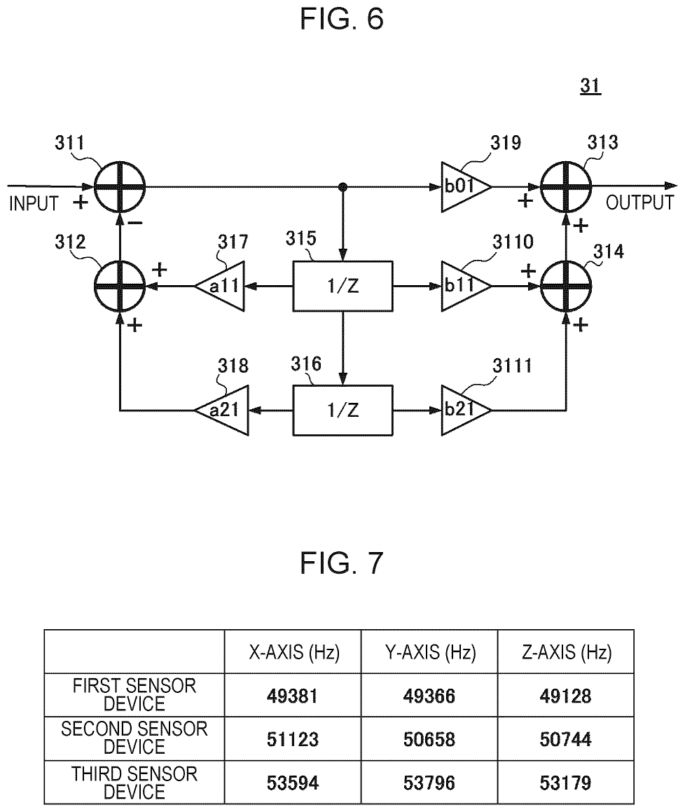

To attenuate the interference signals having the frequencies corresponding to the difference, the filter processing section 30c is able to perform the band stop filter processing (or notch filter processing). Such digital filter processing may be realized by using various configurations. However, in the present embodiment, the digital filter processing is realized by using a second-order IIR filter 31 illustrated in FIG. 6.

The second-order IIR filter 31 includes addition sections 311 to 314, delay sections 315 and 316, and multiplication sections 317 to 3111. The delay sections 315 and 316 give a unit delay to the input signals and output the respective signals. The multiplication sections 317 to 3111 multiply the input signals by the respective coefficients and output the signals. The coefficients of the multiplication sections 317 to 3111 are a11, a21, b01, b11, and b21 respectively that are indicated in the corresponding multiplication sections 317 to 3111 in FIG. 6. The addition sections 311 to 314 give the illustrated respective signs to the input signals in FIG. 6 and perform addition to output respective signals.

Accordingly, in the example illustrated in FIG. 6, the addition section 311 adds the input signal and a signal that is a negative signal of the feedback signal, and outputs a signal. The signal output from the addition section 311 receives a delay by the delay sections 315 and 316. The signal delayed by the delay section 315 is input to the multiplication sections 317 and 3110 and the delay section 316. The signal delayed by the delay section 316 is input to the multiplication sections 318 and 3111.

The signals input to the multiplication sections 317 and 318 are multiplied by the coefficients all and a21 respectively, are added by the addition section 312, and input to the addition section 311. The signals input to the multiplication sections 3110 and 3111 are multiplied by the filter coefficients b11 and b21 respectively, added by the addition section 314, and then is input to the addition section 313. The addition section 313 receives the input of the signal produced by the multiplication section 319 by multiplying the output of the addition section 311 by the filter coefficient b01. The addition section 313 outputs the sum of the two input signals.

The second-order IIR filter 31 described above becomes a filter with various characteristics by adjusting the filter coefficients b01, b11, b21, a11, and a21. In the present embodiment, the three second-order IIR filters 31 that receive the input of the statistical signals on the respective axes are disposed in parallel to perform filtering of the statistical signals on the X-axis, the Y-axis, and the Z-axis in parallel.

In the present embodiment, the filter processing section 30c specifies the filter coefficients such that the individual second-order IIR filters 31 become the band stop filters that stop desired frequency bands. That is, the storage device 50 stores the filter coefficients for realizing the band stop filters that attenuate the respective frequency bands in association with the frequency bands.

The filter processing section 30c then performs processing for obtaining the filter coefficients associated with the frequency bands including the differences obtained in step S120 for the individual axes. For example, in the example illustrated in FIG. 5, when obtaining the filter coefficients about the X-axis, the filter processing section 30c selects a frequency band having a cutoff frequency fcl of the lower frequency side of the band stop filter, which is smaller than the minimum difference value 15, and a cutoff frequency fch of the higher frequency side, which is larger than the maximum difference value 253. When there are a plurality of selectable frequency bands, the filter processing section 30c selects the narrowest frequency band, for example.

When the frequency band is selected, the filter processing section 30c refers to the storage device 50 and obtains the filter coefficients b01, b11, b21, a11, and a21 associated with the frequency band. The filter processing section 30c performs the same processing for the Y-axis and the Z-axis, and determines the filter coefficients for the individual axes. With the configuration described above, it is possible to easily set a filter that eliminates the interference signals having frequencies in accordance with the drive frequencies.

Next, the filter processing section 30c applies the filter coefficients to the second-order IIR filter 31 (step S130). That is, the filter processing section 30c applies the filter coefficients on the individual axes obtained in step S125 to the second-order IIR filters 31 corresponding to the individual axes. With the configuration described above, the second-order IIR filters 31 corresponding to the individual axes function as the band stop filters that attenuate the respective interference signals that might occur on the individual axes.

The processing section 30 determines the digital signal after the interference signals are attenuated to be detection data, and outputs the detection data to an external device via the communication circuit 40. With the configuration described above, the external device is able to obtain the physical quantities along the individual axes by using the statistical signals from which the interference signals have been eliminated. Accordingly, it is possible to obtain physical quantities without being influenced by the interference signals, and to prevent decreases in the detection accuracies of the physical quantities.

Also, in the present embodiment, the interference signals to be eliminated occur in the frequency band in accordance with the drive frequencies of the detection elements that detect the physical quantities on the identical axes. In the present embodiment, the filter processing is performed on the interferences of signals on the identical axes, but the filter processing is not performed on the interferences of signals on different axes. Accordingly, compared with the configuration in which the filter processing is performed on the interferences of signals on the different axes, it is possible to eliminate the influence caused by the interference signals with easy processing.

### 2. Other Embodiments and the Like

The embodiment described above is an example for carrying out the present disclosure, and various embodiments may be employed. For example, the frequencies of the interference signals to be eliminated by the filter processing section 30c are the frequencies having relatively small values (lower than or equal to 1000 Hz in the embodiment described above). However, the interference signals having any frequencies may be the target of the processing performed by the filter processing section 30c. Also, the sensor devices may be used for various applications. For example, the sensor devices may be used for various electronic devices, vehicle-mounted devices, and the like. For the vehicle-mounted devices, various navigation devices, a control device for autonomous driving, and the like are given. Further, the sensor devices may be used for a positioning device that locates the position of a vehicle.

Further, in the embodiment described above, the interference signals having the frequencies in accordance with the difference between the drive frequencies for detecting the physical quantities on the identical axes are the filtering target. However, the present disclosure is not limited to such a configuration. For example, the filter processing section 30c may have the configuration in which the interference signals in the frequency band in accordance with the respective drive frequencies of the detection elements that detect the physical quantities on the different axes are attenuated from the statistical signals, and then the statistical signals may be output as the detection data.

FIG. 7 is an example illustrating the respective drive frequencies of the first detection element 21, the second detection element 22, and the third detection element 23 individually included in the first sensor device 20a, the second sensor device 20b, and the third sensor device 20c. In this example, the differences between the drive frequencies of the detection elements in the same sensor device are relatively small, and the differences between the drive frequencies of the detection elements in the different sensor devices are relatively large.

In this example, it is assumed that the frequencies corresponding to the differences between the drive frequencies of the detection elements in the identical sensor devices are the frequencies to be eliminated by the filter processing section 30c, and the frequencies corresponding to the differences between the drive frequencies of the detection elements in the different sensor devices are not the frequencies to be eliminated by the filter processing section 30c.

In this case, the respective statistical signals on the X-axis, the Y-axis, and the Z-axis might include the interference signals having the frequencies to be eliminated. Thus, the filter processing section 30c applies the band stop filters that attenuate the frequency bands including the frequencies to be eliminated to the corresponding statistical signals on the individual axes. With the configuration described above, it is possible to eliminate the interference signals that occur by driving the detection elements in the identical sensor devices at similar drive frequencies from the statistical signals, and thus it is possible to prevent decreases in the detection accuracies caused by the interference signals.

Further, when regarding a sensor device including the detection elements that detect the respective physical quantities on the first axis, the second axis, and the third axis as a set of sensor devices, the first sensor device 20a, the second sensor device 20b, and the third sensor device 20c, described above, are able to be regarded as three sets of sensor devices. In this configuration, the filter processing section 30c may have the configuration in which the interference signals in the frequency band in accordance with the respective drive frequencies of any detection elements are attenuated from the statistical signals, and then the statistical signals are output as detection data. For example, when the frequency corresponding to the difference between the drive frequencies of any two detection elements is relatively small, and thus the frequency should be eliminated by the filter processing section 30c, the filter processing section 30c applies a band stop filter that attenuates a frequency band including the difference. With the configuration described above, it is possible to eliminate the interference signals that occur by driving any detection elements at respective drive frequencies that are close to each other from the statistical signals, and prevent decreases in the detection accuracies caused by the interference signals.

Further, when it is apparent that the difference between the drive frequencies is smaller than or equal to a predetermined frequency, for example, in a case in which the specifications of the detection elements are within a scheduled range, and with the detection elements have the specifications within the scheduled range, an example in which the difference between the drive frequencies is smaller than or equal to a predetermined frequency is assumed. In this case, the processing section 30 may have the configuration in which the statistical signals produced by making statistics of the detection signals are obtained in accordance with the detection signals from the two or more detection elements, and the interference signals having a frequency lower than or equal to the predetermined frequency are attenuated from the statistical signals, and the statistical signals may be output as detection data. With the configuration described above, it is possible to prevent decreases in the detection accuracies caused by the interference signals without performing processing to obtain the difference between the drive frequencies. Of course, with this configuration, the drive frequencies of the detection elements described above may not be stored in the storage section.

The detection elements only need to be elements that detect physical quantities, and the physical quantities of the detection target are not limited to the angular accelerations described above, and may be various quantities. For example, angular velocities, accelerations, speeds, distances, pressures, sound pressures, magnetic quantities, and the like may be the detection target.

The storage section only needs to store the drive frequencies of the detection elements. Of course, the storage section may store the other information. The drive frequencies of the detection elements may differ for each detection element, and thus the storage section stores the drive frequencies for driving the individual detection elements. The storage section that stores the drive frequencies may be located in the sensor apparatus 10.

The processing section only needs to obtain the statistical signals produced by making the statistics of the detection signals in accordance with the detection signals output from two or more detection elements, and attenuate the interference signals in the frequency band in accordance with the respective drive frequencies from the statistical signal to output as detection data. That is, the processing section improves the statistical accuracies of the detection signals by using the detection signals of two or more detection elements and obtains the statistical signals. Also, the processing section only needs to attenuate the interference signals from the statistical signals, and to output as detection data.

The detection signals only need to be signals indicating physical quantities detected by the respective detection elements, and may be signals with various corrections and the like. The statistical signals only need to be signals produced by making statistics of the detection signals. That is, the processing section only needs to be able to obtain statistical signals indicating the physical quantities with higher accuracy than one detection signal by using a plurality of detection signals. The statistical method is not limited to the averaging described above, and various statistics may be performed. For example, a mode, a median, or the like may be obtained in accordance with a plurality of detection signals to output statistical signals.

The interference signals are signals that occur in the state in which two or more detection elements are used in close proximity and are signals in the frequency band in accordance with the drive frequencies. Accordingly, the interference signals might change in accordance with the drive frequencies. Thus, the processing section determines the frequency band of the interference signals in accordance with the drive frequencies stored in the storage section, and performs the filtering for attenuating the interference signals in the frequency band.

It is possible to realize a filter that attenuates the signals in a specific frequency band by using various configurations. For example, the IIR filter described above is not limited to have the configuration illustrated in FIG. 6, and may be realized by various publicly known configurations. For example, a higher-order IIR filter than the second-order IIR filter may be used, the IIR filters may be coupled in series, or a FIR (finite impulse response) filter or the like may be used. Also, when the statistical signals or the like are analog signals, the filtering may be performed by using an analog filter with variable frequency band.

The frequency band only needs to include the interference signals, for example, as the embodiment described above, the frequencies of the interference signals are estimated by the differences between the drive frequencies. Accordingly, the processing section only needs to attenuate the frequency band including the frequencies. When the sensor apparatus includes three or more detection elements, there are a plurality of combinations of any two detection elements. The frequency band may be determined to include the differences between the drive frequencies with each other for all the combinations of these, or the frequency band may be determined so as to include the differences between the drive frequencies with each other for a part of the combinations of these. For example, when the differences between the drive frequencies are smaller than or equal to a threshold value, the frequencies of the differences may be configured to be included in the frequency band. On the other hand, when the differences between the drive frequencies are larger than the threshold value, the frequencies of the differences may be configured not to be included in the frequency band. As the latter, for example, the interference signals that are able to be attenuated by reusing a filter different from the filter for attenuating the interference signals may be attenuated by reusing the filter.

What is claimed is:

1. A sensor apparatus comprising:
two or more detection elements;
a storage section configured to store respective drive frequencies of the two or more detection elements; and
a processing section configured to, in accordance with respective detection signals output from the two or more detection elements, obtain a statistical signal by making statistics of the detection signals, attenuate an interference signal in a frequency band in accordance with the respective drive frequencies of the two or more detection elements from the statistical signal, thereby outputting detection data.

2. The sensor apparatus according to claim 1, wherein
the two or more detection elements individually include the detection elements that output the detection signals for detecting physical quantities on an identical axis, and
the processing section attenuates the interference signal in a frequency band in accordance with the respective drive frequencies of the detection elements that detect physical quantities on the identical axis from the statistical signal, thereby outputting the detection data.

3. The sensor apparatus according to claim 1, wherein
the two or more detection elements individually include the detection elements that output the detection signals for detecting physical quantities on different axes, and
the processing section attenuates the interference signal in a frequency band in accordance with the respective drive frequencies of the detection elements that detect physical quantities on the different axes from the statistical signal, thereby outputting the detection data.

4. The sensor apparatus according to claim 1, wherein
the two or more detection elements individually include multiple sets of the detection elements that detect physical quantities on a first axis, a second axis, and a third axis that are perpendicular to each other, and
the processing section attenuates the interference signal in a frequency band in accordance with the respective drive frequencies in accordance with any of the detection elements from the statistical signal, thereby outputting the detection data.

5. The sensor apparatus according to claim 1, wherein
the processing section attenuates the interference signal in a frequency band in accordance with two drive frequencies among the respective drive frequencies of the two or more detection elements from the statistical signal, thereby outputting the detection data.

6. The sensor apparatus according to claim 1, wherein
the frequency band is a band including a difference between two drive frequencies among the respective drive frequencies of the two or more detection elements.

7. The sensor apparatus according to claim 1, wherein
the two or more detection elements include a first detection element and a second detection element,
the storage unit stores a first drive frequency of the first detection element and a second drive frequency of the second detection element, and
the frequency band is a band including a difference between the first drive frequency and the second drive frequency.

8. A sensor apparatus comprising:
two or more detection elements; and
a processing section configured to, in accordance with respective detection signals output from the two or more detection elements, obtain a statistical signal by making statistics of the detection signals, attenuate an interference signal having a frequency lower than or equal to a predetermined frequency from the statistical signal, thereby outputting the detection data.

9. A sensing method comprising:
in accordance with respective detection signals output from two or more detection elements, obtaining a statistical signal by making statistics of the detection signals; and
attenuating an interference signal in a frequency band in accordance with drive frequencies of the two or more detection elements from the statistical signal.
